(19) United States
(12) Patent Application Publication
(10) Pub. No.: US 2026/0328657 A1
(43) Pub. Date: Oct. 22, 2026

(54) ULTRASONIC BUBBLE REMEDIATION

(71) Applicant: Labcyte Inc., San Jose, CA (US)

(72) Inventors: Theresa Stelter, San Jose, CA (US); Xu Du, San Jose, CA (US); Stephen Hinkson, San Jose, CA (US); Eric Hobson, San Jose, CA (US)

(21) Appl. No.: 19/115,575

(22) PCT Filed: Oct. 5, 2023
(86) PCT No.: PCT/US2023/076031

§ 371 Date: Mar. 26, 2025

Related U.S. Application Data
(60) Provisional application No. 63/414,322, filed on Oct. 7, 2022.

(51) Int. Cl. G01N 1/28; G01N 29/22

(52) U.S. Cl. CPC G01N 1/286; G01N 29/221; G01N 29/222; G01N 2291/101

(57) ABSTRACT

A system for measuring a sample contained in a container comprises: a transducer assembly configured to receive a plurality electronic transmission signals and emit a corresponding plurality of transmitted acoustic signals towards the container and the Surface sample, and configured to receive reflected acoustic signals from the container or the sample and generate a corresponding plurality of electronic reception signals; transmit signal circuitry configured to generate and communicate the electronic transmission signals to the transducer assembly; receive signal circuitry configured to receive the electronic reception signals from the transducer assembly; and a processor configured to control the transmit signal circuitry and receive information corresponding to the electronic reception signals from the receive signal circuitry, wherein the plurality of transmitted acoustic signals comprises a sequence of a first ping, a first bubble-destroying signal, and a second ping, wherein the plurality of reflected acoustic signals comprises a first TB reflection corresponding to the first ping and a second TB reflection corresponding to the second ping, and wherein the system is configured to emit a second bubble-destroying signal based on a comparison of a characteristic of the first TB reflection and a characteristic of the second TB reflection.

### CROSS REFERENCE TO RELATED APPLICATIONS

The present application claims priority to U.S. Prov. No. 63/414,322, filed on Oct. 7, 2022, the entirety of which is herein incorporated by reference.

### BACKGROUND

Acoustic droplet ejection (ADE) is a technology that uses acoustic energy to move a liquid without any physical contact. Some examples of ADE technology are disclosed in U.S. Pat. No. 10,156,499, which is incorporated herein by reference in its entirety. Acoustic energy (e.g., in the form of ultrasonic pulses) is emitted from a transducer towards a volume of liquid (hereinafter, “sample”). In some examples, the beam converges on or near the upper surface of the sample, and the acoustic energy is transferred to a portion of the sample, thereby causing this portion to move upwardly away from the remainder of the sample (e.g., as a droplet). The sample may be contained in a well (also referred to herein as a container) of a plate (e.g., 96- or 384-well microplate).

### SUMMARY

According to embodiments, a system for measuring a sample contained in a container, wherein the container includes a bottom surface having a bottom-of-bottom interface (BB) and a top-of-bottom interface (TB), comprises: a transducer assembly configured to receive a plurality electronic transmission signals and emit a corresponding plurality of transmitted acoustic signals towards the container and the sample, and configured to receive reflected acoustic signals from the container or the sample and generate a corresponding plurality of electronic reception signals; transmit signal circuitry configured to generate and communicate the electronic transmission signals to the transducer assembly; receive signal circuitry configured to receive the electronic reception signals from the transducer assembly; and a processor configured to control the transmit signal circuitry and receive information corresponding to the electronic reception signals from the receive signal circuitry, wherein the plurality of transmitted acoustic signals comprises a sequence of a first ping, a first bubble-destroying signal, and a second ping, wherein the plurality of reflected acoustic signals comprises a first TB reflection corresponding to the first ping and a second TB reflection corresponding to the second ping, and wherein the system is configured to emit a second bubble-destroying signal based on a comparison of a characteristic of the first TB reflection and a characteristic of the second TB reflection. The characteristic of the first TB reflection may comprise a first peak amplitude and the characteristic of the second TB reflection comprises a second peak amplitude, and wherein system may further be configured to emit the second bubble-destroying signal if the first peak amplitude is greater than the second peak amplitude. A peak amplitude of the first ping and a peak amplitude of the second ping may be substantially identical. An overall energy of the first bubble-destroying signal may be greater than an overall energy of the first ping and greater than an overall energy of the second ping. The transducer assembly may be configured to focus acoustic energy at a first height when emitting the first ping, the first bubble-destroying signal, and the second ping, and wherein the transducer assembly may be configured to focus acoustic energy at a second height above the first height when emitting the second bubble-destroying signal. The first height may be predetermined with respect to the TB, and wherein the second height may be substantially at a surface of the sample. The first height is between +/−6 mm with respect to the TB. The first bubble-destroying signal may include a variable frequency. An energy of the second bubble-destroying signal may be selected to not cause a droplet to be entirely ejected from the sample. The second bubble-destroying signal may include a pre-conditioning signal selected to destroy bubbles and a subsequent conditioning signal selected to destroy bubbles. The pre-conditioning signal may be a bubble-destroying signal. The transducer assembly may be configured to emit second bubble-destroying signal while focusing acoustic energy substantially at the surface of the sample. The container may be included in a plate comprising a plurality of containers containing a corresponding plurality of samples, wherein each of the plurality of containers may include a corresponding BB and TB, wherein the system may further include at least one motor configured to move at least one of the plate or the transducer assembly, such that the transducer assembly is positioned underneath each of the plurality of containers, wherein the system may further be configured to cause the transducer assembly to emit the sequence of the first ping, the first bubble-destroying signal, and the second ping for each of the plurality of containers, and wherein the system may further be configured to cause the transducer assembly to emit the second bubble-destroying signal for given ones of the plurality of containers based on comparisons of a characteristic of the first TB reflection for a given container and a characteristic of the second TB reflection for the given container. The system may further be configured to emit the second bubble-destroying signals for given ones of the plurality of containers after the first ping, the first bubble-destroying signal, and the second ping have been emitted for each of the plurality of containers.

According to embodiments, a method for measuring a sample contained in a container is provided, wherein the container includes a bottom surface having a bottom-of-bottom interface (BB) and a top-of-bottom interface (TB), the method comprising: receiving, at a transceiver assembly, a plurality of electronic transmission signals; transmitting, by the transceiver assembly, a plurality of transmitted acoustic signals towards the container and the sample, wherein the plurality of transmitted acoustic signals correspond to the plurality of electronic transmission signals; receiving, at the transceiver assembly, a plurality of reflected acoustic signals from the container or the sample; generating, by the transceiver assembly, a plurality of electronic reception signals corresponding to the plurality of reflected acoustic signals; generating, by transmit signal circuitry, the plurality of electronic transmission signals and communicating the plurality of electronic transmission signals to the transducer assembly; receiving, at receive signal circuitry, the plurality of electronic reception signals from the transducer assembly; and controlling, with a processor, the transmit signal circuitry; receiving, at the processor, information corresponding to the electronic reception signals from the receive signal circuitry, wherein the plurality of transmitted acoustic signals comprises a sequence of a first ping, a first bubble-destroying signal, and a second ping, wherein the plurality of reflected acoustic signals comprises a first TB reflection corresponding to the first ping and a second TB reflection corresponding to the second ping, and, further comprising, emitting, by the transducer assembly, a second bubble-destroying signal based on a comparison of a characteristic of the first TB reflection and a characteristic of the second TB reflection. The characteristic of the first TB reflection comprises a first peak amplitude and the characteristic of the second TB reflection may include a second peak amplitude, and the method may further include emitting, by the transducer assembly, the second bubble-destroying signal if the first peak amplitude is greater than the second peak amplitude. A peak amplitude of the first ping and a peak amplitude of the second ping may be substantially identical. An overall energy of the first bubble-destroying signal may be greater than an overall energy of the first ping and greater than an overall energy of the second ping. The method may further include focusing, with the transceiver assembly, acoustic energy at a first height when emitting the first ping, the first bubble-destroying signal, and the second ping; and focusing, with the transceiver assembly, acoustic energy at a second height above the first height when emitting the second bubble-destroying signal. The first height may be predetermined with respect to the TB, and wherein the second height may be substantially at a surface of the sample. The first height may be between +/−6 mm with respect to the TB. The first bubble-destroying signal may include a variable frequency. An energy of the second bubble-destroying signal may be selected to not cause a droplet to be entirely ejected from the sample. The second bubble-destroying signal may include a pre-conditioning signal selected to destroy bubbles and a subsequent conditioning signal selected to destroy bubbles. The pre-conditioning signal may be a bubble-destroying signal. The method may further include emitting, by the transceiver assembly, a second bubble-destroying signal while focusing acoustic energy substantially at the surface of the sample. The container may be included in a plate comprising a plurality of containers containing a corresponding plurality of samples, wherein each of the plurality of containers includes a corresponding BB and TB, and the method may further include: moving, with at least one motor, at least one of the plate or the transducer assembly, such that the transducer assembly is positioned underneath each of the plurality of containers, emitting, by the transducer assembly, a sequence of the first ping, the first bubble-destroying signal, and the second ping for each of the plurality of containers, and emitting, by the transducer assembly, the second bubble-destroying signal for given ones of the plurality of containers based on comparisons of a characteristic of the first TB reflection for a given container and a characteristic of the second TB reflection for the given container. The transducer assembly may further emit the second bubble-destroying signals for given ones of the plurality of containers after the first ping, the first bubble-destroying signal, and the second ping have been emitted for each of the plurality of containers. A non-transitory computer-readable medium containing instructions that, when executed by a processor, may perform any one of the foregoing method embodiments.

According to embodiments a system for reducing bubbles in a sample contained in a container using an ultrasonic system having a transducer assembly, wherein the container includes a bottom surface having a bottom-of-bottom interface (BB) and a top-of-bottom interface (TB), wherein the bubbles in the sample about the TB, includes: a transducer assembly configured to align a focal point of an acoustic energy beam, wherein a height of the focal point is substantially at an upper surface of the sample, wherein the transducer assembly is further configured to emit a bubble-destroying signal while the height of the focal point is substantially at the upper surface of the sample, and wherein the bubble-destroying signal comprises a peak amplitude selected to prevent complete ejection of a drop from the sample. The system may be configured to perform at least one measurement to determine the peak amplitude of the bubble-destroying signal. The peak amplitude may include substantially a maximum amplitude before a drop would be completely ejected from the sample. The bubble-destroying signal may further include: a maximum-amplitude determination signal selected to determine a maximum amplitude of an acoustic signal by processing a reflection of the maximum-amplitude determination signal from the upper surface of the sample, wherein an acoustic signal having an amplitude greater than the maximum amplitude would cause a drop to be ejected from the sample; and a bubble-mitigation signal including a peak amplitude determined according to the maximum amplitude. The maximum-amplitude determination signal may include: a first perturbing signal selected to perturb the upper surface of the sample; a first measurement signal following the first perturbing signal, wherein the first measurement signal is selected to be reflected by the upper surface of the sample, whereby the reflection of the first measurement signal is processed to determine a zero velocity drop; a second perturbing signal following the first measurement signal, wherein the second perturbing signal is selected to perturb the upper surface of the sample, wherein a peak amplitude of the second perturbing signal is greater than a peak amplitude of the first perturbing signal; and a second measurement signal following the second perturbing signal, wherein the second measurement signal is selected to be reflected by the upper surface of the sample, whereby the reflection of the second measurement signal is processed to determine the zero velocity drop. The system may be further configured to emit a sequence of additional perturbing signals and additional measurement signals, wherein the additional perturbing signals have increasing peak amplitudes. The bubble-mitigation signal may include a plurality of signals, each having a peak amplitude determined according to the maximum amplitude. Each of the plurality of signals in the bubble-mitigation signal may have a duration of at least 8 us.

According to embodiments, a method is provided for reducing bubbles in a sample contained in a container using an ultrasonic system having a transducer assembly, wherein the container includes a bottom surface having a bottom-of-bottom interface (BB) and a top-of-bottom interface (TB), wherein the bubbles in the sample about the TB, the method includes: aligning, using the transducer assembly, a focal point of an acoustic energy beam, wherein a height of the focal point is substantially at an upper surface of the sample; and emitting, using the transducer assembly, a bubble-destroying signal while the height of the focal point is substantially at the upper surface of the sample, wherein the bubble-destroying signal comprises a peak amplitude selected to prevent complete ejection of a drop from the sample. The method may further include performing at least one measurement to determine the peak amplitude of the bubble-destroying signal. The peak amplitude may include substantially a maximum amplitude before a drop would be completely ejected from the sample. The bubble-destroying signal may further include: a maximum-amplitude determination signal selected to determine a maximum amplitude of an acoustic signal by processing a reflection of the maximum-amplitude determination signal from the upper surface of the sample, wherein an acoustic signal having an amplitude greater than the maximum amplitude would cause a drop to be ejected from the sample; and a bubble-mitigation signal including a peak amplitude determined according to the maximum amplitude. The maximum-amplitude determination signal may include: a first perturbing signal selected to perturb the upper surface of the sample; a first measurement signal following the first perturbing signal, wherein the first measurement signal is selected to be reflected by the upper surface of the sample, whereby the reflection of the first measurement signal is processed to determine a zero velocity drop; a second perturbing signal following the first measurement signal, wherein the second perturbing signal is selected to perturb the upper surface of the sample, wherein a peak amplitude of the second perturbing signal is greater than a peak amplitude of the first perturbing signal; and a second measurement signal following the second perturbing signal, wherein the second measurement signal is selected to be reflected by the upper surface of the sample, whereby the reflection of the second measurement signal is processed to determine the zero velocity drop. The method may further include a sequence of additional perturbing signals and additional measurement signals, wherein the additional perturbing signals have increasing peak amplitudes. The bubble-mitigation signal may include a plurality of signals, each having a peak amplitude determined according to the maximum amplitude. Each of the plurality of signals in the bubble-mitigation signal may have a duration of at least 8 us. A non-transitory computer-readable medium containing instructions that, when executed by a processor, may perform any one of the foregoing method embodiments.

According to embodiments a system is provided for determining the presence of bubbles in a sample contained in a container in an ultrasonic system, wherein the container includes a bottom surface having a bottom-of-bottom interface (BB) and a top-of-bottom interface (TB), the system comprising: an ultrasonic transducer assembly configured to emit a first ping having a first energy, further configured to emit a second ping having a second energy subsequent to the bubble-destroying signal, further configured to emit a higher-energy signal subsequent to the first ping and prior to the second ping, wherein the higher-energy signal has an energy greater than the first energy and the second energy, further configured to receive a first reflected signal reflected from the TB from the first ping, and further configured to receive a second reflected signal reflected from the TB from the second ping; and a processor configured to infer the presence of bubbles in the sample when a peak amplitude of the first reflected signal is greater than a peak amplitude of the second reflected signal.

According to embodiments, a method is provided for determining the presence of bubbles in a sample contained in a container in an ultrasonic system having an ultrasonic transducer assembly and a processor in communication with the ultrasonic transducer assembly, wherein the container includes a bottom surface having a bottom-of-bottom interface (BB) and a top-of-bottom interface (TB), the method comprising: emitting, from the ultrasonic transducer assembly, a first ping having a first energy; emitting, from the ultrasonic transducer assembly, a second ping having a second energy subsequent to the bubble-destroying signal; emitting, from the ultrasonic transducer assembly, a higher-energy signal subsequent to the first ping and prior to the second ping, wherein the higher-energy signal has an energy greater than the first energy and the second energy; receiving, by the ultrasonic transducer assembly, a first reflected signal reflected from the TB from the first ping; receiving, by the ultrasonic transducer assembly, a second reflected signal reflected from the TB from the second ping; and inferring, by the processor, the presence of bubbles in the sampler when a peak amplitude of the first reflected signal is greater than a peak amplitude of the second reflected signal. A non-transitory computer-readable medium may contain instructions that, when executed by a processor, performs any of the foregoing method embodiments.

According to embodiments, a method for performing sonoporation on a sample including cells in the sample contained in a container, wherein the container includes a bottom surface having a bottom-of-bottom interface (BB) and a top-of-bottom interface (TB), includes: transmitting, by an transducer assembly configured to transmit and receive acoustic signals, a ping towards the sample; receiving, at the transducer assembly, a reflected signal from the ping including a reflection from the TB and from a surface of the sample; measuring, with a processor, an energy of the reflected signal; and estimating, with the processor, a quantity of bubbles based on the energy of the reflected signal. Said estimating the quantity of bubbles may be based at least partially on the energy of a reflection from the TB in the reflected signal. Said estimating the quantity of bubbles may be based at least partially on the energy of a reflection from the surface of the sample in the reflected signal. Said estimating the quantity of bubbles may be based at least partially on the energy of a reflection from the surface of the sample in the reflected signal. The energy of the reflected signal may correspond to a peak amplitude of the reflected signal for a given reflection. The method may further include: transmitting, with the transducer assembly, a bubble-destroying signal configured to destroy at least a portion of the bubbles; transmitting, with the transducer assembly, a second ping towards the sample; receiving, with the transducer assembly, a second reflected signal in response to the second ping, wherein the second reflected signal includes a reflection from the TB and a reflection from the surface of the sample; measuring, with the processor, an energy of the second reflected signal; and estimating, with the processor, a second quantity of bubbles based on the energy of the second reflected signal. Said estimating the second quantity of bubbles may be based at least partially on the energy of reflection from the TB in the second reflected signal. Said estimating the quantity of bubbles may be based at least partially on the energy of a reflection from the surface of the sample in the reflected signal. Said estimating the quantity of bubbles may be based at least partially on the energy of a reflection from the surface of the sample in the reflected signal. The method may further include transmitting a second bubble-destroying signal configured to destroy at least a portion of the bubbles based on the second quantity of bubbles. The second bubble-destroying signal may be different than the bubble-destroying signal. The second bubble-destroying signal may be determined by the processor based at least in part of the second quantity of bubbles. The method may further include performing transfection on cells in the sample. The method may further include predicting an efficiency of the transfection based at least in part on the quantity of bubbles. A system may be configured to perform any one of the foregoing method embodiments. A non-transitory computer-readable medium containing instructions that, when executed by a processor, may perform any one of the foregoing method embodiments.

### BRIEF DESCRIPTION OF SEVERAL VIEWS OF THE DRAWINGS

FIG. 1 shows a representation of an ADE system, including a cross-sectional view a container plate including a plurality of containers (or wells) holding a respective plurality of samples, receiver plate, a transducer assembly, and a block diagram of electronic circuitry.

FIG. 2 shows a block diagram of a transducer assembly.

FIG. 3 shows a representation of movement of the transducer assembly relative to a container plate when performing ADE on multiple samples.

FIG. 4 shows a top view of a container plate with a plurality of containers.

FIG. 5 shows a top view of a plurality of containers in a container plate and a flow illustrating a sequence for serially performing ADE on each container.

FIG. 6 shows a container holding a sample.

FIG. 7 shows a reflected signal and corresponding envelope, where the reflected signal is received at transceiver assembly in response to an emitted signal.

FIG. 8 shows an image from a scanning electron microscope of an inner surface at a top-of-bottom interface (TB) of an exemplary container.

FIG. 9A shows an image from a scanning electron microscope of TB in a container holding a sample not affected by bubbles.

FIG. 9B shows an image from a scanning electron microscope of TB in a container holding a sample affected by bubbles.

FIG. 10 shows a sequence for bubble remediation, according to certain embodiments.

FIG. 11 shows a top view of a container plate having certain containers having samples with bubbles.

FIG. 12 shows a flowchart for a method of removing bubbles, according to embodiments.

FIG. 13 shows a flowchart for a method of removing bubbles, according to embodiments.

FIG. 14 illustrates stabilization of reflections from TB in a container holding a sample affected by bubbles.

FIG. 15 illustrates stabilization of a zero velocity droplet (ZVD) in a container holding a sample affected by bubbles.

FIGS. 16A, 16B, and 16C show illustrative examples of reflections of a ping when there are different quantities of bubbles, according to embodiments.

FIGS. 17A, 17B, 17C, and 17D show illustrative examples of reflections of a ping after different bubble-destroying signals have been emitted, according to embodiments.

FIG. 18 shows four microscope images of cells with attached bubbles after a bubble-destroying signal has been emitted, according to embodiments.

FIG. 19 shows a flowchart for a method of removing bubbles, according to embodiments.

FIG. 20 shows a graph of signals indicative of a reduction in bubbles in different samples, according to embodiments.

FIG. 21 shows a graph indicating a reduction in bubbles in different samples, according to embodiments.

FIG. 22 shows a graph with the x-axis showing transfection efficiency for A549 cells as a percentage and the y-axis showing bubble clearance as a percentage, according to embodiments.

FIG. 23 shows a graph with the x-axis showing transfection efficiency for HEK-293 cells as a percentage and the y-axis showing bubble clearance as a percentage, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

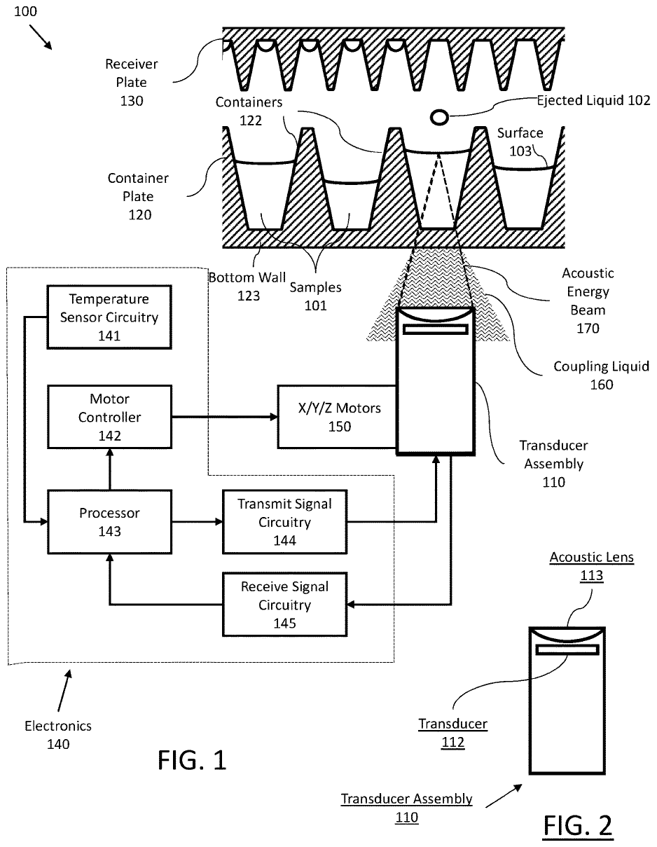

FIG. 1 depicts an exemplary representation of an ADE system 100, including a cross-sectional view of a container plate 120 (e.g., a microplate) including a plurality of containers 122 (e.g., wells of a microplate) holding a respective plurality of samples 101, receiver plate 130 including a plurality of receiver wells that receive ejected liquid 102 from sample 101, and a block diagram of electronics 140. ADE system 100 further includes transducer assembly 110, coupling liquid 160, X/Y/Z motors 150 (or fewer than all three dimensions-e.g., no vertical (Z) motor), and/or temperature sensors (not shown). FIG. 2 further shows transducer assembly 110, including transducer 112 and acoustic lens 113. ADE system 100 can determine characteristics of containers 122 and/or samples 101, as well as cause liquid to be ejected. A given sample 101 is a liquid of interest that is held within a corresponding container 122. Although this disclosure focuses on containers 122 that are wells of microplates, techniques described herein can be used with other containers 122 such as tubes, flasks, and beakers, as well as any samples 101 contained therein.

In order to cause ejected liquid 102 to be ejected from sample 101, transducer 112 generates acoustic energy (e.g., ultrasonic energy), which is focused by acoustic lens 113 into beam 170. In the figures, beam 170 is shown in two dimensions, but beam 170 is actually three dimensional. Furthermore, while beam 170 is shown as a perfect triangle, beam 170 can have different shapes. It may possible to vary the height of the focal point of acoustic energy beam 170 by adapting the configuration of transducer assembly 110. For example, the focal length of beam 170 may be changeable by adapting transducer assembly 110. Such a transducer assembly 110 is described in U.S. application Ser. No. 16/369,780 (U.S. Publ. 2019/0302063), which is herein incorporated by reference in its entirety. It may also be possible to change the height of the focal point by moving transducer assembly 110 along the z-axis (i.e., the vertical dimension between container 122 and transducer assembly 110).

As depicted in FIG. 1, beam 170 is focused on the upper surface of sample 101, which may be at the interface between sample 101 and the air above sample 101. First, beam 170 passes through coupling liquid 160, a bottom wall 123 of container 122, and then the depth of sample 101 to reach the surface 103 of sample 101.

Electronic circuitry 140 includes processor 143, motor controller 142, transmit signal circuitry 144, receive signal circuitry 145, and temperature sensor circuitry 141. Although shown as separate components for explanatory purposes, portions of electronics 140 may be combined or integrated. Furthermore, some components shown may include multiple different subcomponents not specifically shown. For example, processor 143 may include multiple processors (for example, multiple processors distributed at different locations).

Processor 143 causes or controls transmit signal circuitry 144 to generate an analog electrical signal (electronic transmission signal, such as a radio frequency (RF) signal), which is communicated to transducer 112. Transducer 112 then vibrates in response to the analog signal (amplitude and frequency), such that a corresponding acoustic signal is emitted. Transducer assembly 110 may also receive acoustic signals (e.g., acoustic signals reflected from container 120 or samples 101 in response to the emitted acoustic signal) and vibrate sympathetically. This may generate an analog electrical signal (electronic reception signal), which is then communicated to receive signal circuitry 145. Processor 143 may receive information corresponding to the received acoustic signals from the receive signal circuitry 145 in the form of an electronic reception signal. The information in the electronic reception signal will be analyzed by processor 143.

Processor 143 can also communicate with motor controller 142 to control the location of transducer assembly 110. Motor controller 142 controls one or more of X/Y/Z motors 150 (again, not all X, Y, and Z motors are required) to move transducer assembly 110 relative to container plate 120. As shown, X/Y/Z motors 150 are coupled (directly or indirectly) to transducer assembly 110, but these or other motors may be coupled (directly or indirectly) to container plate 120 and/or receiver plate 130 in order control the relative movement between transducer assembly 110, container plate 120, and/or receiver plate 130. Processor 143 can control one or motors 150 to position transducer assembly 110 underneath a given container 122 in container plate 120 (e.g., transducer assembly 110 is centered with respect to a center of given container 122), and then to move transducer assembly 110 underneath another given container 122 in container plate 120. Alternatively, or in addition, container plate and/or receiver plate 130 may be translated in one or more X, Y, and Z dimensions using motors or other translation device(s).

In some embodiments, ADE system 100 may include temperature sensor(s) (not shown) that can be located in coupling liquid 160, in a region between container plate 120 and receiver plate 130, or other locations. Temperature sensor circuitry 141 receives signals (e.g., electrical or wireless) from temperature sensor(s), and communicates with processor 143 such that temperature(s) (e.g., of coupling liquid 160, containers 122, samples 101, air temperature) can be measured.

In some embodiments, transducer assembly 110 can have a cylindrical shape. In some examples, instead of using a single transducer 112 to both transmit and receive acoustic signals, transducer assembly 110 may include separate transmitter and receiver transducers, for example, as disclosed in U.S. Pat. No. 10,787,670, which is herein incorporated by reference in its entirety. According to one technique, receiving transducer can substantially surround the transmitting transducer and acoustic lens.

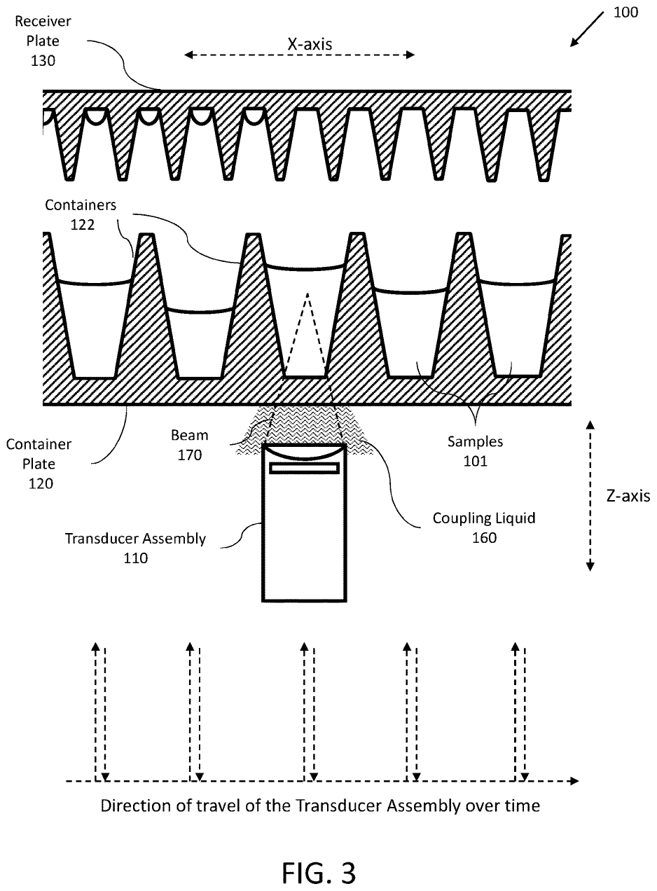

FIG. 3 shows a representation of movement of transducer assembly 110 relative to container plate 120 when performing ADE on multiple samples 101. Transducer assembly 110 is moved from container-to-container 122 along the x-axis. Transducer assembly 110 can also move along the y-axis to additional containers 122 (not shown) as further described with respect to FIG. 5. For each container 122, transducer assembly 110 may be substantially centered underneath container 122. Transducer assembly 110 may move vertically along the z-axis to emit and receive acoustic signals at different z-positions beneath container 122. Transducer assembly 110 can be positioned along the z-axis to focus beam 170 on the surface 103 of sample 101 to cause ejected liquid 102 to be ejected (ADE). As further described below, transducer assembly 110 can be positioned along the z-axis to focus beam 170 at a predetermined height with respect to container plate 120 to destroy bubbles without performing ADE, for example, destroying bubbles that are located at the interface between container 122 and sample 101.

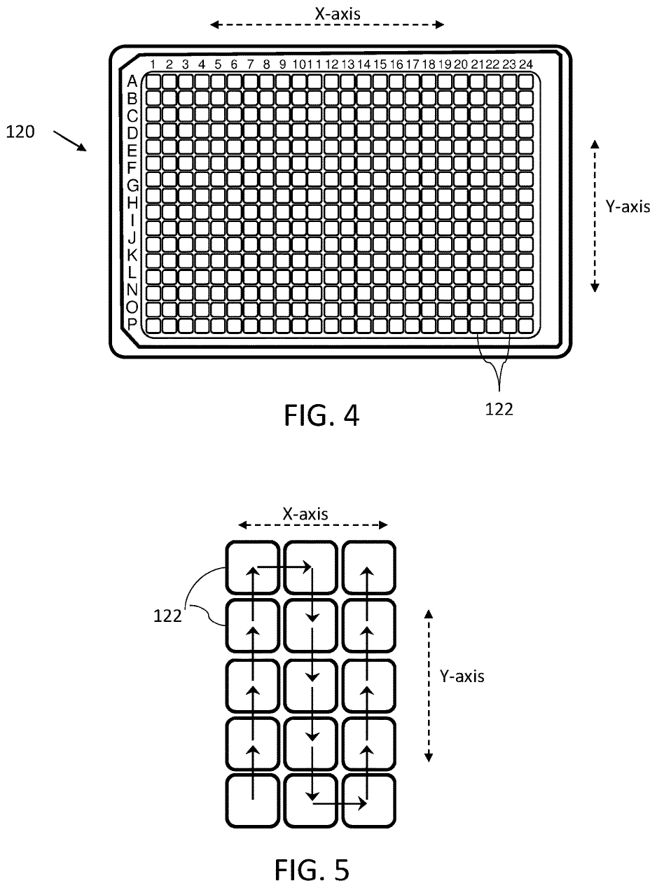

FIG. 4 shows a top view of container plate 120 having a plurality of containers 122. Container plate 120 shown is a 384-well microplate (e.g., a polypropylene microplate, designated 384-PP). FIG. 5 a top view of a plurality of containers 122 and an example pattern (a serpentine pattern) for performing ADE and/or other ultrasonic techniques (such as bubble destruction) on each container 122 and sample 101 therein, as described with respect to FIG. 3. In this example, motors 150 move transducer assembly 110 along the x-and y-axes to position it under various containers 122. Any other suitable pattern may be used (e.g., a raster pattern). It may also be possible to move container plate 120 or a combination of container plate 120 and transducer assembly 110 to achieve similar results.

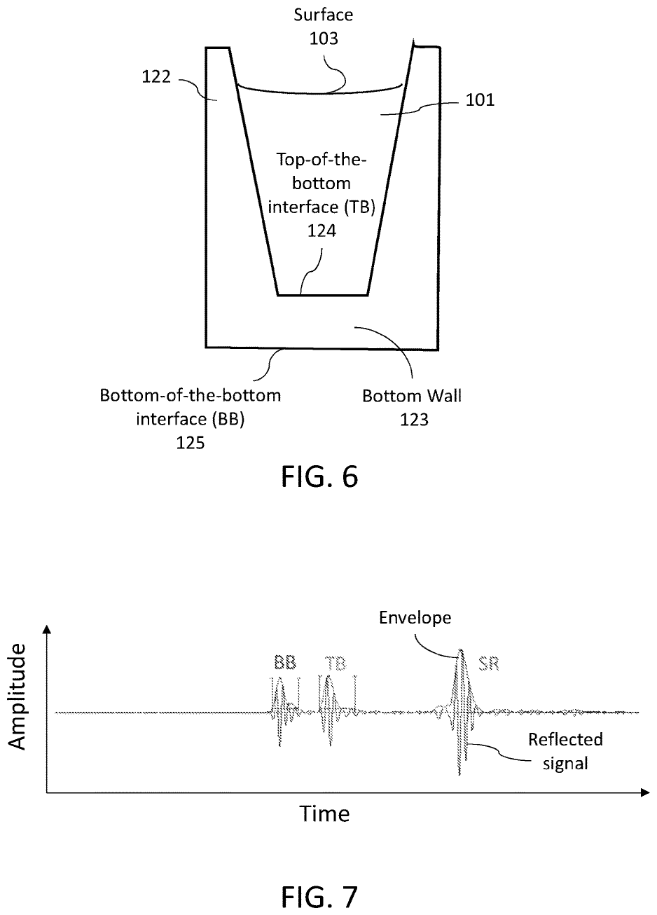

FIG. 6 shows container 122 (or well) holding sample 101, which has a surface 103 (i.e., upper surface or free surface). Bottom wall 123 of container 122 defines a top-of-the-bottom interface (TB) 124 and a bottom-of-the-bottom interface (BB) 125.

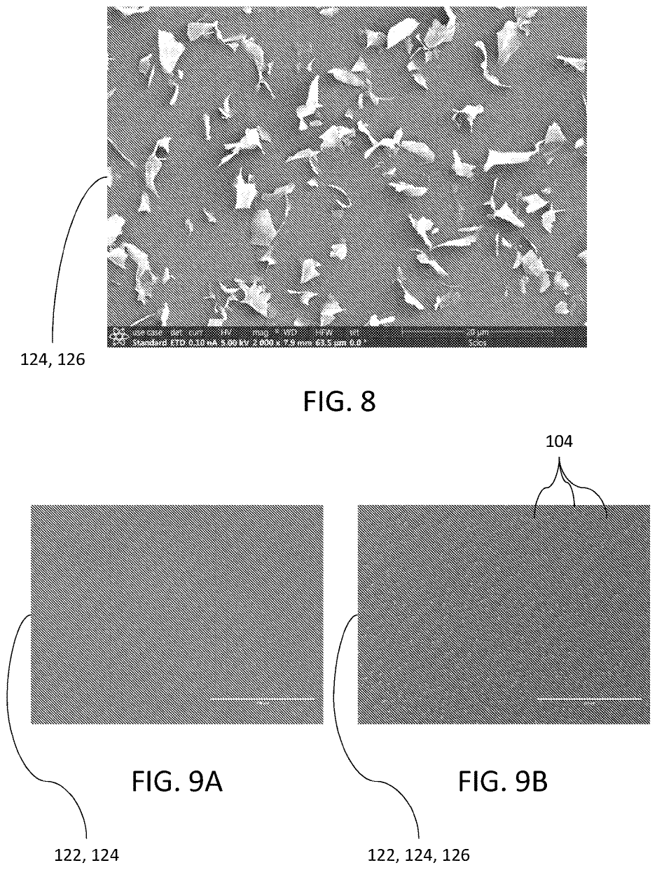

FIG. 7 shows a reflected signal and corresponding envelope, where the reflected signal is received at transceiver assembly 110, in response to an emitted signal. BB indicates a reflection from BB 125. TB indicates a reflection from TB 124. SR (surface reflection) indicates a reflection from surface 103 of sample 101. The overall time at which the reflections appear are referred to as time of flight, or ToF. For each reflection BB, TB, SR in FIG. 7, there is a different, respective ToF. When the distance between the transducer and BB, TB, or surface 103 is generally known, a particular reflection can be identified in the overall reflected signal based on ToF.

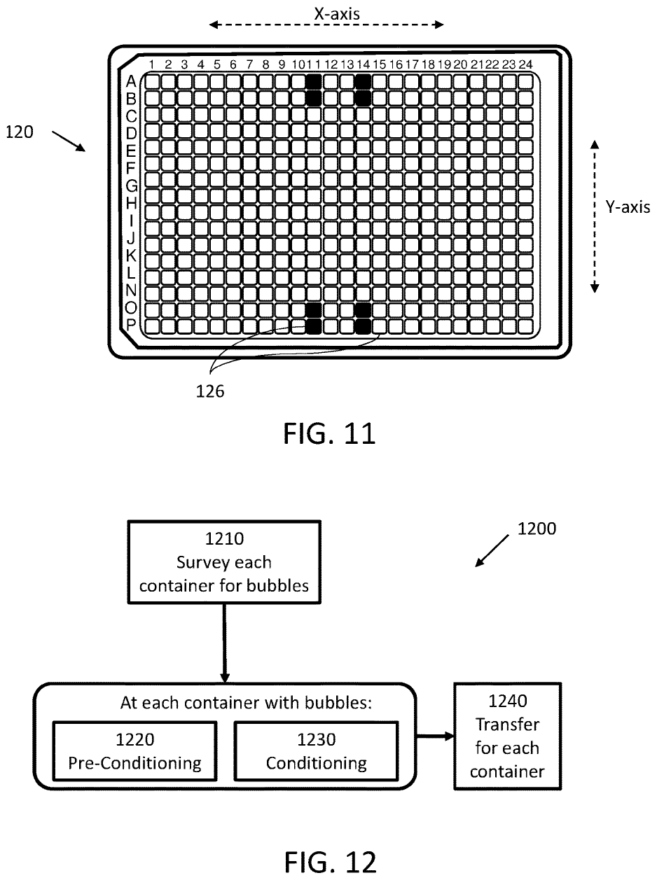

FIG. 8 shows an image from a scanning electron microscope of an inner surface of an exemplary container 122, where the inner surface includes TB 124. Surface texturing on the order of approximately 5-10 μm can be seen (lighter colored, irregular shapes). Such texturing may not appear in all containers 122, but it has been observed that plates 120 may have affected containers 122. As shown in FIG. 11, containers that are affected are referenced as affected containers 126, and affected containers 126 (which may be a subset of containers 122) may occur in the A11, A14, P11, P14, B11, B14, O11, or O14 locations, although other locations are possible. Such locations may be proximate or adjacent to injection molding ports when container plate 120 is being formed. It has been observed that there may be between one to six affected containers 126, although it is possible that plate 120 may have more affected containers 126. Such texturing may be caused by separation of components of the plastic during molding and/or the molding process parameters (e.g., temperature and pressure gradients). However, the techniques described herein are not necessarily specific to the texture shown in FIG. 8. Instead, techniques described herein are applicable to a variety of conditions that may benefit from bubble remediation.

As shown in FIGS. 9A and 9B, texturing may result only in affected containers 126. FIG. 9A shows a microscopic view of a TB 124 of an unaffected container 122 including sample 101. FIG. 9A shows that there are few, if any, bubbles. FIG. 9B shows a similar microscopic view of a TB 124 of an affected container 126 including sample 101. In FIG. 9B, it can be seen that bubbles 104 form at TB 124. As used herein, an affected container 126 is also a type of container 122.

Bubbles 104 have been observed in, for example, affected containers 126 filled with a sample 101 including Milli-Q® water, 1X phosphate-buffered saline (PBS), <=14% critical micelle concentration of Triton X-100 in 1X PBS, or 70%-80% dimethyl sulfoxide in water. Bubbles 104 may have a diameter between 1.5-5 μm, although, as will be recognized, techniques described herein are not limited to a specific bubble 104 size.

Bubbles 104 at TB 124 may impact the acoustic ejection process. For example, bubbles 104 may increase acoustic reflection from TB 124. Referring back to FIG. 7, acoustic energy beam refracts through BB 125 and TB 124 and reaches the surface 103 of sample 101. Once surface 103 is reached, a liquid mound is created and then ejected liquid 102 is ejected. However, in an affected container 126, bubbles 104 may cause a larger than normal reflection from TB 124. This may be due to a greater acoustic impedance mismatch between affected container 126 material (e.g., polypropylene) and gas trapped in bubbles 104, as compared to acoustic impedance mismatch between container 126 material and sample 101 without bubbles 104. In affected container 126, bubbles 104 may not cover 100% of the area where the acoustic energy beam intersects TB 124, but bubbles 104 may be relatively evenly dispersed across TB 124. The reflected signal may include reflections from areas of TB 124 where there are no bubbles 104, and areas of TB 124 where there are bubbles 104. For the reflections from portions of the beam that do not intersect bubbles 104, the reflected energy may be of a typical amplitude expected from TB 124. For reflections from portions of the beam that intersect bubbles 104, the emitted signal may actually strike two interfaces: first, a TB 124 to gas interface at the lower surface of the bubble 104 adhered to TB 124; and second a gas/fluid interface at the top of the bubble 104. The reflections from these two interfaces may be nearly simultaneous, given that they are separated in time by on the order of 10s of nanoseconds. The combined reflections due to bubbles 104 may be substantially greater in energy than reflections from TB 124 without any bubbles 104.

The energy reflected from TB 124 in affected container 126 including sample 101 has been observed to be as much as 3 times higher than with unaffected containers 122 including sample 101. In some cases, the received energy from TB 124 at transducer assembly 110 may be so high as to saturate receive signal circuitry 145 (exceed acceptable operating range). This may cause problems, such as false identification of empty containers 122. When reflected energy from TB 124 saturates receive signal circuitry 145 (or otherwise is sufficiently high), this may identify (or assist in identifying) empty containers 122. However, if bubbles 104 are present, a given container 122 may be falsely identified as not containing a sample 101. Another problem for affected containers 126, may be incorrect assessment of sample 101 for calibrations that account for an impedance signature of a container 122 and/or sample 101.

An additional possible problem is that bubbles 104 may attenuate or decrease the signal directed to surface 103 of sample 101 during a mound imaging process (MIP) and drop ejection. Decreases may be due to increased reflection, energy dispersion, and/or energy used in bubble destruction. For example, ADE may use MIP to determine adequate power amplitude for drop ejection, whereas duration of an ejecting acoustic signal may be fixed. Bubbles 104 may require transducer assembly 110 to emit higher energy or power due to the power loss at TB 124 (e.g., energy lost due to reflection, dispersion, and any energy used in bubble 104 removal). As acoustic power continues to project on TB 124, bubbles 104 tend to burst and acoustic attenuation starts to decrease. As a result, over time, more acoustic power or energy reaches the surface 103 of sample 101, thereby decreasing the precision of ADE because of the time-varying nature of the signal.

One known technique to address interference of bubbles 104 is to reduce the amplitude of the emitted signals (e.g., survey pings). However, the reflection from TB 124 in affected containers 126 may remain higher than in containers 122 that are not affected containers 126. This may mean that the challenges to signature calibrations are not addressed. Signature calibration may rely on TB 124 reflections and BB 125 reflections to determine properties of the bottom wall 123 and the sample 101 (e.g., acoustic impedance of sample 101), as relevant to ADE.

As an example, assume a first amplitude for the emitted signal, and peak reflections from BB 125 (1000 counts), from TB 124 in containers 122 that are unaffected (1000 counts), and from TB 124 in affected containers 126 (3000 counts), where a count is an increment on an analog-to-digital (A/D) converter. Herein, “counts” refers to the fitted envelope value. In this example, the A/D converter has a maximum range of 2048 counts, so a signal of 3000 counts will saturate the A/D converter. If amplitude of the emitted signal is decreased to a second value, the peak amplitudes of the reflected energy may be halved (500, 500, and 1500 counts, from BB 125, TB 124 in unaffected containers 122, and TB 124 in affected containers 126, respectively). In this example the A/D converter may no longer be saturated by peak amplitude of the reflected signal from TB 124 in an affected container 126. However, the ratio of the peak amplitude reflection from TB 124 to BB 125 in an affected container is still relatively high (3x), and may result in incorrect identification of fluid properties by signatures.

Additionally, even if affected containers 126 may not be deemed to be empty and the process does proceed to ADE transfer, these transfers may suffer from incorrect volume and/or poor placement because the instability (e.g., not repeatedly measured to be substantially constant) of the “zero velocity droplet” (ZVD) is not addressed. MIP may allow for calculation of the ZVD (the amplitude of the acoustic signal required to just break off drop 102, but without the energy necessary to cause drop 102 to separate from surface 103 of sample 101). Accordingly, drop 102 may fall back into the sample 101. Once determined, the ZVD value may be scaled to the amplitude required to fully eject drop 102 from sample 101 and container 122. The instability of the ZVD may be caused by the changing attenuation as bubbles 104 are destroyed. If there are substantially no bubbles 104 at TB 124, MIP may result in stable values. Likewise, if there are bubbles 104 at TB 124 that act as an attenuator, but bubbles 104 are not being destroyed, MIP may determine the ZVD to be a higher value (to compensate for attenuation), but the system may still be able to eject drop 102 consistently (and reproducibly). Instability may arise from the fact that MIP is assessing a system with an additional attenuator (in this case, bubbles 104), but the degree of attenuation of this additional attenuator is changing (bubbles 104 are being destroyed). As a result, ZVD may be too high, and drop 102 may be inadvertently ejected.

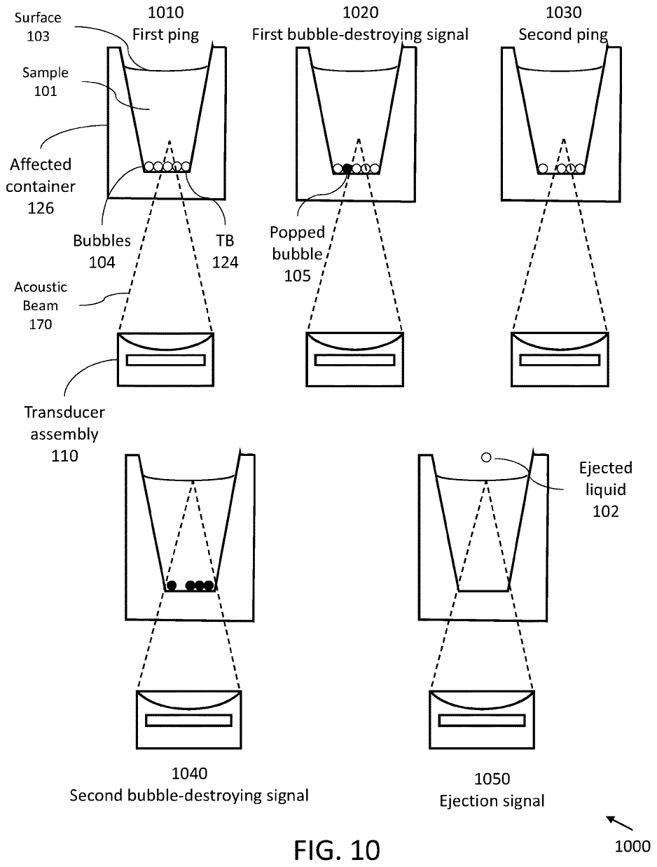

FIG. 10 illustrates a sequence 1000 for bubble 104 remediation, according to certain embodiments. In sequence 1000, transducer assembly 110 may emit acoustic energy beam 170 having a focal length (e.g., 6 mm to 51 mm, such as 25 mm). Transducer assembly 110 may define a constant focal length (i.e., cannot change the focal length), or focal length may be adjustable. In steps 1010, 1020, and 1030, focal length of acoustic energy beam 170 extends to the same focal point at a predetermined height, such as a height above TB 124 and/or predetermined with respect to TB 124. Such a predetermined height may be −4 to +4 mm below or above TB 124, such as +2.5 mm above TB 124. It may be possible to vary the height of focal point (or otherwise change focal length) between steps 1010, 1020, 1030. It may be beneficial to adapt the position and/or shape of acoustic energy beam 170 (either by z-axis movement of transducer assembly 110 or varying focal length with transducer assembly 110). For example, it may be beneficial to match or correlate a cross-section of acoustic energy beam 170 with surface area of TB 124. In steps 1040, 1050, focal point of acoustic energy beam 170 is shifted to surface 103 of sample 101. Alternatively, focal point could be between 4 mm above surface 103 to 16 mm below surface 103.

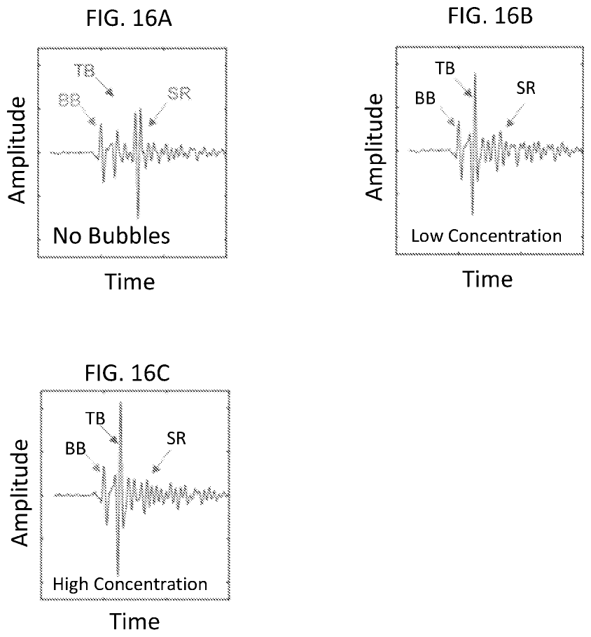

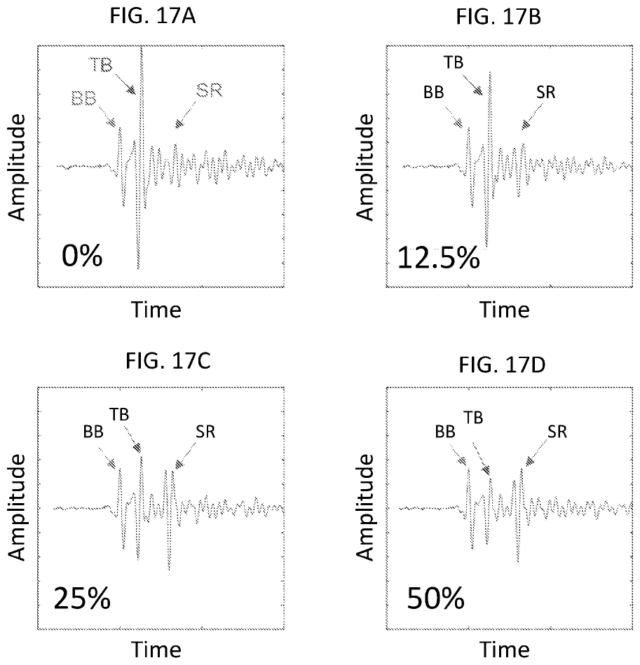

At step 1010, transducer assembly 110 emits a first ping in an acoustic energy beam 170. A ping may be a type of acoustic signal that may have a relatively short duration (e.g., 5 ns to 200 ns, such as 40 ns) and relatively low energy (e.g., 0.1 μJ to 10 μJ, such as 1 μJ). A ping may have a peak power of up to 100 Watts. A ping may include acoustic energy transmitted at in a broad spectrum (e.g., center frequency of 12 MHz and a bandwidth of 6 MHz). To generate the data shown in FIGS. 16, 17, and 20-23, a ping having a single cycle of a 2.25 MHz square wave was used. TB 124 reflects a portion of first ping as a first TB reflection (not shown). Transducer assembly 110 receives first TB reflection and the information may be processed by processor 143. The reflection from the first ping may indicate the presence of bubbles. Turning to FIGS. 16A-16C, there is shown an illustrative example of how the presence of bubbles may be determined by processing the reflection from the ping. FIG. 16A is an illustrative example in which there are substantially no bubbles. In this case, the TB reflection is relatively low and the SR reflection is relatively high. FIGS. 16B and 16C are additional illustrative examples in which there are an increasing number (concentration) of bubbles. As the number of bubbles increases, the peak amplitude of TB reflection increases and the peak amplitude of SR reflection decreases.

Turning back to FIG. 10, at step 1020, transducer assembly 110 emits a first bubble-destroying signal. Such signal may be longer in duration than first ping or second ping (discussed below). First bubble-destroying signal may be referred to as a dimple. First bubble-destroying signal duration may be 8 μs to 500 μs, such as 90 μs. First bubble-destroying signal may have a lesser amplitude than first ping or second ping, such as 10 W to 50 W of peak power, such as 20 W of peak power. First bubble-destroying signal may have a varying frequency, such as a chirp. The chirp may have a programmable varying pattern. The varying frequency may vary from as low as, e.g., 0.5 MHz to as high as, e.g., 20 MHz, with an exemplary range of 6 MHz to 14 MHz. First bubble-destroying signal has an overall energy that may be greater than that of first ping or second ping (described below). The overall energy of first bubble-destroying signal may be 0.1 mJ to 10 mJ, such as 2 mJ.

First bubble-destroying signal may be selected to destroy (or pop) at least some bubbles 104. FIG. 10 designates such a destroyed bubble as a solid-black circle, popped bubble 105. First bubble destroying signal may impart energy to bubbles 104 at TB 124. One bubble destruction mechanism may be bubble cavitation. Energy input to a given bubble 104 at relevant frequencies results in expansion of the bubble 194. As bubble 104 radius increases, surface tension may no longer be sufficient to sustain the bubble 104. Bubble 104 may increase in size until the signal is stopped, and then the bubble 104 may break into many substantially smaller bubbles (i.e., bubble destruction). Another bubble destruction mechanism may be through bubbles being pushed upward and dislodging from TB 124.

According to embodiments, steps 1010 and 1020 may be repeated before step 1030, either identically or with varying parameters as discussed above.

At step 1030, transducer assembly 110 emits a second ping in an acoustic energy beam 170. Second ping may be identical or substantially identical to first ping-e.g., the peak amplitudes of the first ping and second ping may be substantially identical. Alternatively, second ping could differ from first ping. For example, different ping amplitudes may be useful if a calibration covers a wide range of types of samples 101, some samples 101 causing relatively small TB reflections and some causing relatively large TB reflections. Using different ping amplitudes during this process may provide information useful to other processes while still being compatible with bubble 104 detection.

TB 124 reflects a portion of second ping as a second TB reflection. Transducer assembly 110 receives second TB reflection and the information may be processed by processor 143. Because some bubbles 104 have been popped by first bubble-destroying signal in step 1020, a lesser fraction of acoustic energy may be reflected from TB 124 than for first ping in step 1010.

Processor 143 compares first TB reflection (from step 1010) and second TB reflection (from step 1030), by comparing at least one characteristic for each. Examples of such a characteristic include overall energy or peak amplitude. In the case that the characteristic for each is the peak amplitude, such peak amplitude could be for the signal itself or corresponding envelope for the signal, such as a Hilbert envelope. If the at least one characteristic in second TB reflection is different than expected (e.g., different than the case when there are no bubbles 104 or other types of interference), then processor 143 infers that bubbles 104 are present at TB 124. For example, first ping and second ping may be identical. Therefore, theoretically, the first TB reflection and the second TB reflection should be identical under ideal circumstances. However, if second TB reflection is less than first TB reflection (e.g., has a lower peak amplitude or overall energy), then it may be inferred that bubbles 104 are present at TB 124, based on the principles of reflection described above. In this example, second TB reflection was expected to be identical to first TB reflection if there were no bubbles (or other interference). The criterion/criteria for inferring the presence of bubbles 104 may vary from circumstance to circumstance, such as calibration of a given system.

Examples of such criterion/criteria for inferring the presence of bubbles 104 are various ratios, such as: TB″/TB′; or (TB″/BB″)/(TB′/BB′), where BB′ and TB′ are reflections from BB 125 and TB 124 from the first ping, and where BB″ and TB″ are reflections from BB 125 and TB 124 from the second ping. If such ratios are below given threshold(s) (e.g., 0.6 to 0.95), then the presence of bubbles 104 may be inferred.

At step 1030, if the presence of bubbles 104 at TB 124 is inferred, then the flowchart 1000 proceeds to step 1040. Otherwise, the sequence 1000 may skip step 1040 and proceed to step 1050. According to embodiments, steps 1020 and/or 1030 may be repeated before step 1040, either identically or with varying parameters as described above.

At step 1040, a second bubble-destroying signal is emitted by transducer assembly 110. Second bubble-destroying signal may be selected to destroy substantially all bubbles 104 at TB 124 (or a substantial portion thereof). Embodiments of second bubble-destroying signal are described below in context of FIGS. 12, 13, and 15.

According to certain embodiments, the second bubble-destroying signal includes a preconditioning signal and a conditioning signal. Each may take place with acoustic energy beam 170 focused on surface 103 of sample 101 (e.g., above the focus height in steps 1010, 1020, and 1030. As transfer, described in step 1050, may take place with acoustic energy beam 170 focused on the same location, any bubbles 104 at TB 124 in the path of beam 170 may be destroyed before transfer. Preconditioning signal may destroy some, but not all bubbles 104. Preconditioning may reduce the impact of bubbles 104, such that during the conditioning signal, the rate of change of bubble 104 impact is not too large to cause overpowering (such that a drop is accidentally ejected) before being recalculated in the next iteration. One possible, but not necessary result of skipping preconditioning, is that during the conditioning process (discussed below), energy reaching surface 103 for the “fake transfers” may increase as bubbles 104 are destroyed, and the energy may increase to a level where a drop 102 is inadvertently ejected.

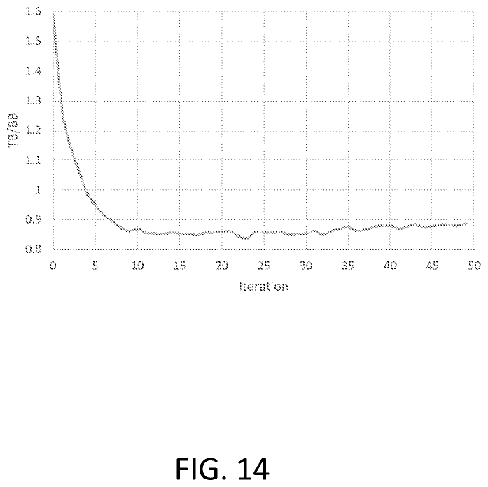

Preconditioning signal may have an amplitude and frequency selected to prevent liquid from being ejected. The amplitude may be fixed. The amplitude may be predetermined, for example, by sweeping a range of frequencies and amplitudes within test samples for a given calibration. Preconditioning may include a shorter signal (e.g., a similar duration to the first bubble-destroying signal) that is emitted repeatedly (e.g., 50 times). During the course of this repetition the reflection of acoustic energy from TB 124 may lessen until it stabilizes to a substantially constant value (e.g., within an acceptable range). As bubbles 104 continue to be destroyed at TB 124, less and less acoustic energy is reflected, for the reasons discussed above. TB reflections may be monitored by system 100, for example, to determine when such reflections are repeatedly at a substantially constant value (e.g., within an acceptable range). If stabilization of TB reflections occurs sooner than a maximum number of iterations, the preconditioning signal may terminate then. FIG. 14 illustrates stabilization of reflections from TB 124 in an example affected container 126 as iterations continue. The y-axis represents the ratio of the peak amplitude of the reflection from TB 124 and the reflection from BB 125. The reflection from BB 125 may be substantially constant throughout the bubble 104 destruction process.

Conditioning signal may be used to remove substantially any remaining bubbles 104 at TB 124. Preconditioning may not use a substantially maximum amplitude of acoustic energy, so that ejection can be avoided. Instead, preconditioning may use a fixed amplitude, as discussed above. Conditioning, in contrast, may involve a process where the maximum amplitude is empirically determined for each container 122 and then acoustic energy is emitted at substantially the maximum amplitude.

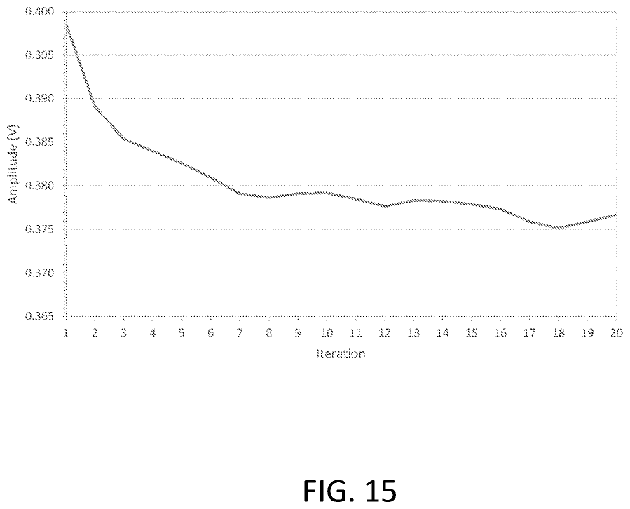

The impacts of remaining bubbles 104 can be a factor in the mound imaging process (MIP). Conditioning signal may stabilize the mound imaging solution. Conditioning signal may include mound imaging followed by multiple drop “fake transfers” (e.g., 20 drops fakely ejected) but without scaling up the ZVD to actually eject liquid. The process of mound imaging followed by multiple fake transfers (no drop ejected) is repeated until the measured ZVD value stabilizes to a substantially constant value (e.g., within an acceptable range). According to certain embodiments, for a given iteration, mound imaging is performed followed by 20 fake transfers, although more or less fake transfers are possible. If ZVD value stabilizes before a maximum number of iterations (e.g., 20 sequences of (mound imaging+multiple fake transfers)), conditioning signal may terminate. Stabilization of ZVD over 20 iterations in an exemplary affected container 126 is shown in FIG. 15. The y-axis represents the calculated ZVD value from each MIP measurement. For each iteration, surface 103 is perturbed with repeated signals of increasing amplitude and measure the mound that is raised by measuring the width of the surface reflection (SR) returned. The width of the SR corresponds to the size of the mound. When a predetermined size is reached, the ZVD can be calculated—i.e., the amplitude required to theoretically break off a drop that is not ejected but falls back into sample 101. For ADE, the amplitude of the acoustic signal is increased to a value greater than ZVD, such that a drop will be ejected. By contrast, fake transfers are performed with the amplitude being the empirically determined ZVD, such that a drop is not likely to be ejected.

As part of the mound imaging process (MIP), a maximum amplitude above which a drop would be ejected may be determined using a maximum-amplitude determination signal. The maximum-amplitude determination signal may include a first perturbing signal, a subsequent first measurement signal, a subsequent second perturbing signal, and a subsequent measurement signal. The first perturbing signal may be selected to perturb the upper surface of the sample, but not eject a liquid. The peak amplitude and duration of the first perturbing signal may be selected according to an experimentally determined range for a representative fluid. The selected peak amplitude may be slightly less than the experimentally determined range. The subsequent first measurement signal may be selected to be reflected by the upper surface of the sample, whereby the reflection is processed by processor 143 to quantify the impact of the perturbation e.g., the size of the mound created by the first perturbing signal. Based on the size of the mound as compared to the amplitude of the first perturbing signal, a ZVD may be determined. The second perturbing signal has a greater peak amplitude than the peak amplitude of the first perturbing signal. The peak amplitude may be increased by a value in the range of 0.02 to 1 dB, such as 0.15 dB. Like the first measurement signal, the second measurement signal may be selected to be reflected such that the processor 143 may quantify the impact of the perturbation—e.g., the size of the mound created by the second perturbing signal. Based on the size of the mound as compared to the amplitude of the second perturbing signal, a ZVD may be determined. Based on the measurement of mound size vs. perturbing signal amplitude, a ZVD can be determined. Perturbing and measurement signals may be repeated, for example, with ever-increasing peak amplitude of the perturbing signals. There may be a total of 1 to 50 paired sets of perturbing and measurement signals (e.g., 10 paired sets). It may also be possible to decrease peak amplitudes if overpowering is detected (e.g., if a drop may start to break off from surface 103).

During the fake transfers, a bubble-mitigation signal with a peak amplitude determined according to the maximum amplitude previously ascertained is employed. For example, the peak amplitude may be equal to or less than the maximum amplitude (e.g., between 0 dB and 10 dB, such as 0.5 dB less than the maximum amplitude). The bubble-destroying signal may include a plurality of such signals (such as two signals), each having a peak amplitude determined according to the previously-ascertained maximum amplitude. A duration of such a signal may be between 8 μs to 500 μs, such as 150 μs.

A bubble-mitigation signal may have a peak amplitude greater than the maximum amplitude. Depending on the application, it may be acceptable to eject a drop as long as the does not have sufficient energy to hit a target or interfere with an assay. For example, the amplitude may between zero and 0.5 dB above ZVD.

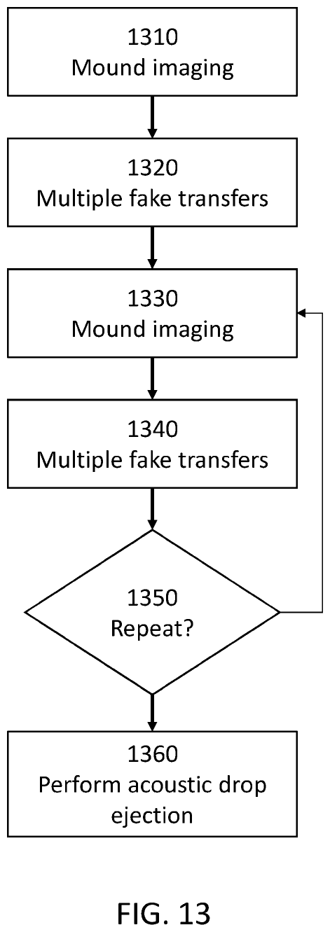

Another embodiment of a conditioning signal is illustrated FIG. 13 in flowchart 1300. At step 1310, mound imaging is performed. At step 1320, multiple fake transfers are performed. At steps 1330, 1340, and 1350, mound imaging and multiple fake transfers (e.g., 20 fake transfers) are repeatedly performed, until ZVD measurement stabilizes (e.g., within an acceptable tolerance). Steps 1330, 1340, 1350 may each be repeated at least a predetermined number of times (e.g., three times) over which ZVD measurement has stabilized. Alternatively, or in addition, steps 1330, 1340, 1350 are repeated a predetermined maximum number of times (e.g., 10 times) irrespectively of whether ZVD measurement has stabilized a predetermined number of times. At step 1360, ADE is performed based on the determined ZVD.

Turning back to FIG. 10, at step 1050, transducer assembly 110 emits a signal to cause droplet 102 to be ejected from sample 101, according to ADE principles. Some examples of ADE are disclosed in U.S. Publ. 2021/0394171 or PCT Publ. WO 2020/092407, both of which are herein incorporated by reference in their entireties.

According to embodiments, a third ping may be emitted before step 1050. The third ping may be similar to the first ping and/or second ping. The reflected signal from the third ping may be processed in a similar manner as with the first ping and/or second ping in steps 1010, 1030, such that it may be inferred whether the bubbles have substantially been destroyed. If the bubbles have not been substantially destroyed, then steps 1020 and/or 1040 may be performed again, either identically or with parameters that vary, as described above. Subsequent ping steps and bubble-destroying steps may be performed any number of times as required or according to design.

FIG. 12 shows a flowchart for a method 1200 of removing bubbles 104, according to embodiments. At step 1210, each container 122 is surveyed for bubbles 104. For each container 112, transducer assembly 110 may be positioned underneath the given container 112. As another option, containers 122 may not be surveyed, but containers 122 at risk of being affected containers 126 (e.g., A 11, A 14, B 11, B 14, 011, 014, P11, or P14, as shown in FIG. 11) may be designated. Step 1210 may correspond to steps 1010 and/or 1030 described in context of FIG. 10. As described in context of FIG. 10, processor 143 may be able to determine which containers 122 have a sample 101 with bubbles 104 (i.e., affected containers 126) by processing information gathered at steps 1010 and 1030.

For every affected container 126 (and/or potentially affected container) identified in step 1210, preconditioning 1220 and conditioning 1230 may be performed. It may be possible to perform only preconditioning 1220, instead of both preconditioning 1220 and conditioning 1230 for each affected container 126 or potentially affected container. It may be possible to perform preconditioning 1220 and/or conditioning 1230 on one or more containers 122 that are not affected containers 126. After bubble removal in steps 1220 and/or 1230, the process proceeds to step 1240, in which transfer (ADE) is performed for each container 122. It may be possible to perform steps 1210, 1220, and/or 1230 for plate 120 prior to performing step 1240. Optionally, it may be possible to perform steps 1210, 1220, 1230, and/or 1240 on a given container before sequencing to the next. Step 1240 may correspond to step 1050.

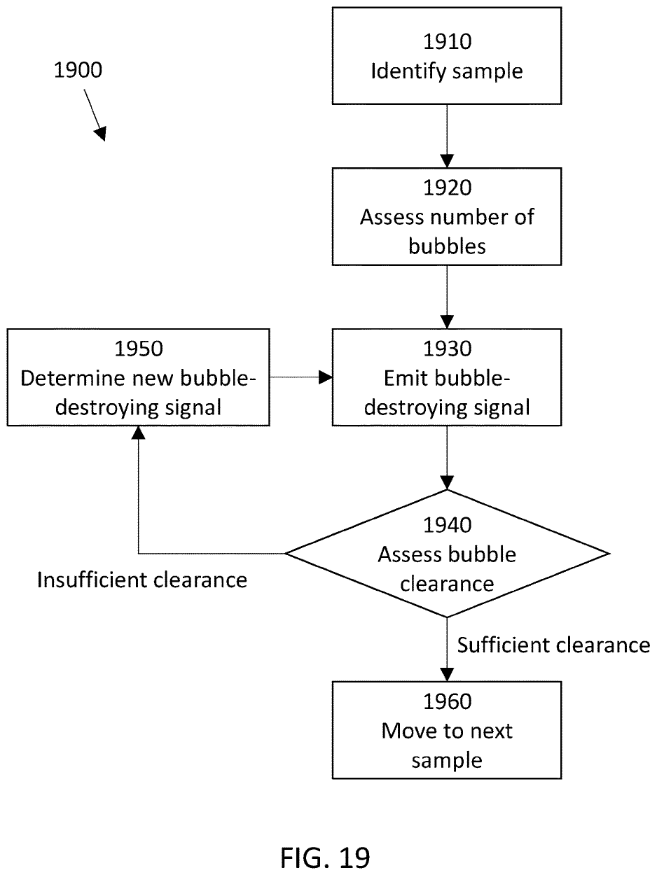

FIG. 19 shows a flowchart 1900 for a method of destroying bubbles, according to embodiments. The method may be performed by components described in context of FIGS. 1 and 2 (e.g., processor 143 and transducer assembly 110). The method may be similar to that disclosed in FIGS. 10, 12, and/or 13. It may not be necessary to perform all steps. For example, steps 1910 and/or 1950 may be bypassed and/or omitted. Further steps may be performed partially or completely concurrently. For example, steps 1910 and 1920 may be performed concurrently. The method corresponding to flowchart 1900 may be used for bubble-destroying techniques in which there is no ADE, such as embodiments of transfection described below. For example, pre-conditioning 1220 and/or conditioning 1230, as described in context of FIG. 12 may not be used.

At step 1910, characteristics of a sample may be identified. Such characteristics may include a presence and/or a volume of liquid in the sample. Such identification may be determined by implementing techniques such as the identification of reflection from physical sample features, including BB, TB, and SR, in collected pulse-echo ultrasound signals. For example, the volume of a sample may be determined by measuring the time of the SR reflection and knowing the dimensions of the container (which may be standard for given types of plates).

At step 1920, a number of bubbles is assessed by inference or estimation. Step 1920 may be similar to steps 1010 or 1030, described in conjunction with FIG. 10. A ping may be transmitted from transducer assembly 110, and the reflected signal may be assessed. Based on the amount of reflected energy from TB and/or SR, the number of bubbles may be estimated. The degree of reflection may be based on a peak amplitude from the TB reflection and/or a peak amplitude from the SR reflection. Examples of how the energy of TB and SR reflections varies based on the number of bubbles in a sample is discussed below in context of FIGS. 16A-16D. The reflected energy can be used by processor 143 as input to an equation, lookup table, or machine-learning model to estimate the quantity of bubbles based on previous empirical evaluations of samples and bubble quantity. The number of bubbles in the sample may be estimated as an absolute number or a concentration.

At step 1930, a bubble-destroying signal may be emitted by transducer assembly 110. Step 1930 may be similar to step 1020 and/or step 1040. At step 1940, the effectiveness of step 1930 of destroying bubbles is assessed. Step 1940 may be similar to step 1920, or steps 1010 and/or 1030 described in context of FIG. 10. The effectiveness of step 1930 may be determined by comparing the estimated number of bubbles with a threshold or some other predetermined method of assessment. If a sufficient number of bubbles were destroyed at step 1930, then the process may move to the next container at step 1960 (e.g., by moving the transducer assembly 110 or plate 120). Alternatively, acoustic droplet ejection may be performed before moving to the next container at step 1960. Acoustic droplet ejection may be performed after all relevant samples have had bubbles destroyed, or before moving to the next container. ADE may or may not be performed with certain transfection techniques. ADE may be performed, for example, after bubbles have been substantially destroyed.

On the other hand, if a sufficient number of bubbles have not been destroyed, then flowchart 1900 may proceed to step 1950. Here, processor 143 may determine parameters of a new bubble-destroying signal, which will be used when step 1930 is repeated. Alternatively, parameters of a new bubble-destroying signal may not be determined, and the same bubble-destroying signal used in the previous iteration of 1930 may be used again. Steps 1930, 1940, and 1950 (optionally) may be repeated until there has been a sufficient clearance of bubbles from the sample.

The embodiments described in conjunction with FIG. 19 (as well as FIGS. 10 and 12) may be used to automatically identify when given samples have a concentration of bubbles different than what is expected (higher or lower). Such identification may happen at step(s) 1920 and/or 1940. Subsequent bubble-destroying signal(s) may be adjusted to compensate for any such variation.

FIGS. 16A-16C illustrate examples of reflections of a ping when there are different quantities of bubbles. The pings are emitted towards a sample, such as described in context of FIGS. 10 and 19. In FIG. 16A, the sample has a lesser number of bubbles, and the amount of bubbles progressively increased in samples 16B and 16C. The y-axis is shown in counts (where a count is an increment on an analog-to-digital (A/D) converter), but is essentially arbitrary and intended to provide a way to objectively compare each of FIGS. 16A-16C with each other. The x-axis is time. As can be seen, in each figure, the peak amplitude of the BB reflection is the same. However, the peak amplitude of the TB reflection increases as the number of bubbles increases in the sample. For transfection (discussed below), many bubbles may be cell-bound, and the cells tend to be heavier than the bulk liquid in the sample, and consequently sink down to or towards the TB. The bubbles form gas pockets, and where gas pockets are located, more acoustic energy will be reflected. Further, as the number of bubbles increases, the peak amplitude of the surface reflection (SR) decreases. This is partially because more energy is being reflected at TB and never reaching the surface of the sample. The reduction in the peak amplitude of the surface reflection may also be caused by suspended bubbles in the bulk liquid of the sample, and possibly a relatively chaotic or irregular surface geometry due to bubbles floating at the surface.

By assessing the reflected energy from TB and/or the surface of the sample, it may be possible to infer the amount of bubbles in the sample as discussed above. For example, it may be possible to use a look-up table based on empirical data to estimate the quantity of bubbles. As another example, a machine-learning model could be used. Training of such a model may involve using training data including transmitted signal waveforms, voltages supplied to the transducer assembly, reflected signal peak amplitudes (e.g., from the surfaces of the samples and TBs), reflected signal waveforms, sample bulk liquid composition, number of cells in a given sample, types of cells in samples, volumes of samples, and/or dimensions of containers.

Additionally, bubbles are known to oscillate at specific resonant frequencies that are related to the size and composition of the individual bubbles. Such composition may include the type of gas inside the bubble and the materials in the bubble shell (e.g., lipid, protein, synthetic polymer, or the like). The density and compressibility of the gas, and the elasticity and surface energy of the shell both may play a role in altering the resonant frequency of the bubbles. This resonant frequency may impact how the bubbles absorb or reflect ultrasonic signals. Frequency analysis of the reflected waveforms may be processed to identify shifts in the reflected and/or absorbed frequency spectra that can further infer characteristics of the bubbles in the sample, thereby providing information on the size distribution of bubbles within a specific container (e.g., the different sizes of bubbles and the number for each of the different sizes, or a curve of size vs. quantity). Such information could also be processed by a conventional algorithm, lookup table, or used to train a machine-learning model. Such a trained model could be used to determine size and composition of bubbles using subsequent waveforms or extracted features therefrom.

FIGS. 17A-17D shows illustrative examples of reflected signals from a ping after different bubble-destroying signals have been emitted. These figures are similar to FIGS. 16A-16D, in that they show a signal reflected from a ping. However, FIGS. 17A-17D illustrate the nature of a reflected ping based on how many bubbles have been destroyed in a previous step. In each example, the same number of bubbles was originally present in a sample before a bubble-destroying signal was transmitted by transducer assembly 110. FIG. 17A shows the baseline condition of a reflected signal from a container containing a sample when no bubble-destroying signal has been transmitted. At FIG. 17B, transducer assembly 110 was provided with an RF electrical signal having a peak voltage 12.5% of the maximum that can be generated by transmit signal circuitry 144 (see FIG. 1). As the reflection from the ping indicates, some of the bubbles in the sample were destroyed, because the peak amplitude of the TB reflection has been reduced and the peak amplitude of SR has increased. At FIG. 17C, transducer assembly 110 was provided with an RF electrical signal having a peak voltage 25% of the maximum by transmit signal circuitry 144. As can be seen, the peak amplitude of the TB reflection is lower than in FIGS. 17A and 17B. Further the peak amplitude of the SR reflection is greater than in FIGS. 17A and 17B. This indicates that more bubbles were destroyed by the bubble-destroying signal generated by the RF electrical signal having a peak voltage of 25% of the maximum, than with an RF electrical signal having a peak voltage of 0% or 12.5% of the maximum. At FIG. 17D, transducer assembly 110 was provided with an RF electrical signal having a peak voltage of 50% of the maximum by transmit signal circuitry 144. As can be seen, the peak amplitude of the TB reflection is lower than in FIGS. 17A, 17B, and 17C. Further the peak amplitude of the SR reflection is greater than in FIGS. 17A, 17B, and 17C. This indicates that more bubbles were destroyed by the bubble-destroying signal generated by the RF electrical signal having a peak voltage of 50% of the maximum, than with an RF electrical signal having a of 0%, 12.5%, or 25% of the maximum.

According to embodiments, the bubble remediation processes described herein can be used in association with transfection procedures. Transfection refers to the process of deliberately introducing genetic materials, including (but not limited to) messenger RNA (mRNA), short interfering RNA (siRNA), or plasmid DNA (pDNA), into eukaryotic cells. One way of performing transfection involves sonoporation. Sonoporation refers to the use of sound in the ultrasonic range for increasing the permeability of the cell plasma membrane. Increasing cell plasma membrane permeability allows uptake of large molecules such as DNA into the cell, for example, as desirable during transfection. Sonoporation employs acoustic cavitation of microbubbles to enhance delivery of these large molecules. Bubbles used for transfection may have a diameter of, for example, 5 μm.

The information generated by assessing and/or controlling the quantity (number and/or concentration) of bubbles in a sample may have certain advantages usable for a transfection process. For example, this may be helpful for quality control. One advantage is to verify the attachment of sufficient bubbles to cells prior to sonoporation, and potentially discriminate between free/bound bubbles using, for example, SR and/or TB reflection information to assess (e.g., quantify) binding efficiency in a given sample. A further advantage is to verify the appropriate clearance of bubbles. This may help to identify any issues with software and/or hardware of the transfection system and/or help to reduce the occurrence of unexplained and/or poor results. A further advantage allows verification that the appropriate samples (including cells, liquid, and bubbles) are in the expected containers. This may flag and/or enable correction of pipetting errors that may otherwise result in failed experiments.

Techniques used herein may be used for real-time and/or closed loop process that improves transfection results. This may enable dynamic adjustment of the number, amplitude, and/or duration of bubble-destroying signals to suit individual samples or containers. This may provide greater flexibility in evaluating unknown samples and may provide improved process reliability by enabling dynamic adjustment of the number, amplitude, and/or duration of bubble-destroying signals to correct for variation in the bubble density resulting from the preparation of samples for sonoporation.

As shown below, data collected during acoustic transfection shows a correlation between the TB reflection signal, the initial bubble density, amplitude of the bubble-destroying signals, and number of bubble-destroying signals applied

Furthermore, it may be helpful to substantially eliminate bubbles after transfection if ADE is used to eject a droplet from the sample, as described herein.

There may be different groups of bubbles that can be detected using the processes described herein. One group is cell-bound microbubbles. As discussed, these may be localized toward the bottom of a container (TB), leading to the formation of, effectively, a gas layer. This gas may cause a larger reflected signal from the TB as compared to a reflection from a substantially bubble-free sample (i.e., without the gas). Other groups of microbubbles may include those suspended in the bulk of the fluid or at the fluid surface. The microbubbles in these locations would not impact the signal from the TB, but may still impact the signal from the surface reflection (SR) via acoustic scattering.

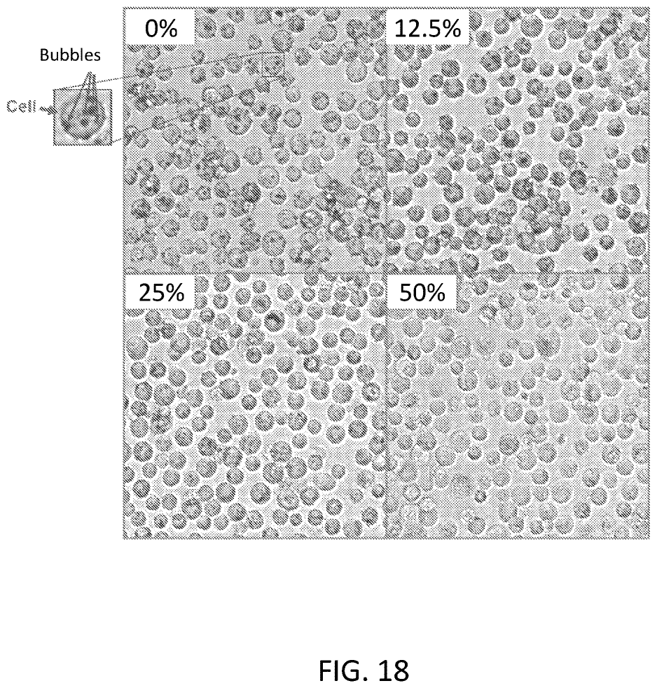

FIG. 18 shows four images from a microscope of cells in a sample with attached microbubbles, which were used as part of transfection processes. The first image is a baseline image in which no bubble-destroying signal has been emitted (0% of maximum signal). In the subsequent images, the number of bubbles on cells is reduced by increasing amounts according to the increasing energy of the bubble-destroying signal (peak voltage provided by transmit signal circuitry 144 to transducer assembly 110 increases from 12.5% of the maximum for the weaker bubble-destroying signal up to 50% of the maximum for the stronger bubble-destroying signal). For these particular examples, the bubble-destroying signal had a frequency of 2.25 MHz, a duration of 12 μs, and a sinusoidal shape.

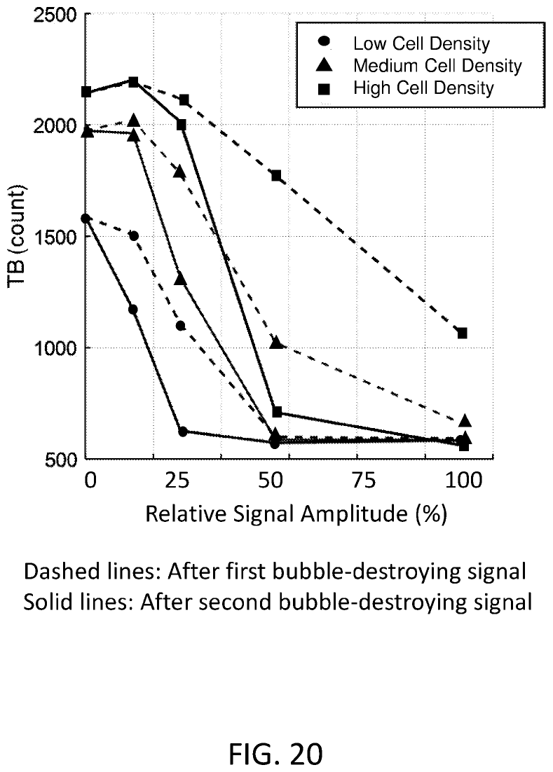

FIGS. 20-23 show the impact and effectiveness of certain techniques disclosed herein on samples containing bubbles and mammalian cells. The samples being assessed were suspensions of mammalian cells at various densities with attached microbubbles. Ultrasonic pings were transmitted to the sample by a transducer assembly, and the reflections therefrom were received by the transducer assembly. Pings were transmitted and corresponding reflections were assessed before and after the transmission of a bubble-destroying signal. The reflected data was interpreted using a custom MATLAB script, reading in all of the stored data and then determining the peak amplitudes of reflections from the BBs of the containers, the TBs of the containers, and the surfaces of the samples.

A certain parameter was used to calculate bubble clearance based on the peak amplitude of the TB reflection. This parameter is based on the decrease in TB reflection amplitude after the application of a bubble-destroying signal to the sample. The clearance=(TBᵢₙᵢₜᵢₐₗ−TB_{current})/(TBᵢₙᵢₜᵢₐₗ−TB_{control}), where TBᵢₙᵢₜᵢₐₗ is the TB reflection amplitude in a container before the bubble-destroying signal is transmitted, TB_{current} is the real-time TB reflection amplitude, and TB_{control} is the TB reflected amplitude of a comparable container without any microbubbles.

In addition to differences observed in the TB reflected signal, there are also differences, presumably induced by bubbles in the signal reflected by surface of a given sample. The SR reflection could also be potentially assessed, as previously explained, but it was not considered for the generation of data depicted in FIGS. 20-23.

FIG. 20 shows a graph of signals indicative of a reduction in bubbles in different samples, according to embodiments. For three types of samples (low cell density, medium cell density, and high cell density), the peak amplitude of the TB reflection in response to an identical ping was measured in counts (where a count is an increment on an analog-to-digital (A/D) converter), but other metrics of measurement would have been possible. The number of cells in a given sample corresponds to the number of bubbles in the given sample, presuming approximately the same number of bubbles bind to a given cell. A first bubble-destroying signal was transmitted, and the peak TB reflection amplitude from a ping was then measured. The magnitude of the first bubble-destroying signal is indicated by voltage supplied to the transducer assembly on the x-axis. The peak TB reflection amplitude is plotted against the magnitude of the first bubble-destroying signal in the dashed-line curves. Further, a second bubble-destroying signal was transmitted, and the peak TB reflection amplitude from an identical ping was then measured. The magnitude of the second bubble-destroying signal is indicated by voltage supplied to the transducer assembly on the x-axis. The peak TB reflection amplitude is plotted against the magnitude of the second bubble-destroying signal in the solid-line curves. As can be seen, a greater magnitude of a bubble-destroying signal results in more bubbles being destroyed.

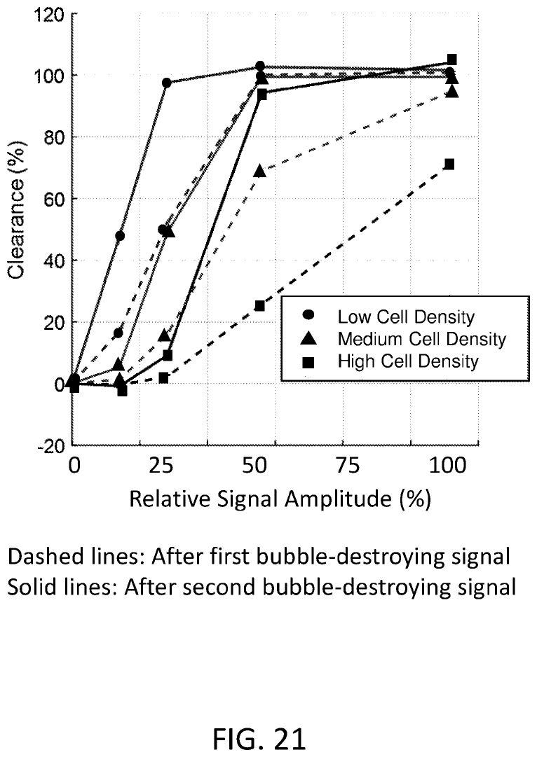

FIG. 21 shows a graph indicating a reduction in bubbles in different samples, according to embodiments. FIG. 21 is similar to FIG. 20, except that FIG. 21 shows the percentage of clearance of bubbles. The parameter for clearance as shown in FIG. 21 is described above—i.e., clearance=(TBᵢₙᵢₜᵢₐₗ−TB_{current})/(TBᵢₙᵢₜᵢₐₗ−TB_{control}).

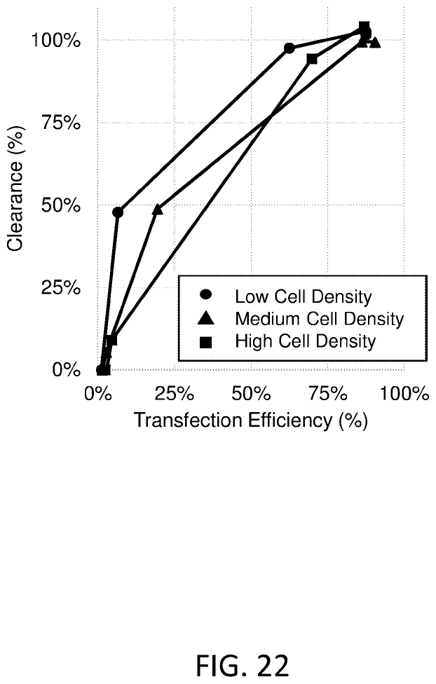

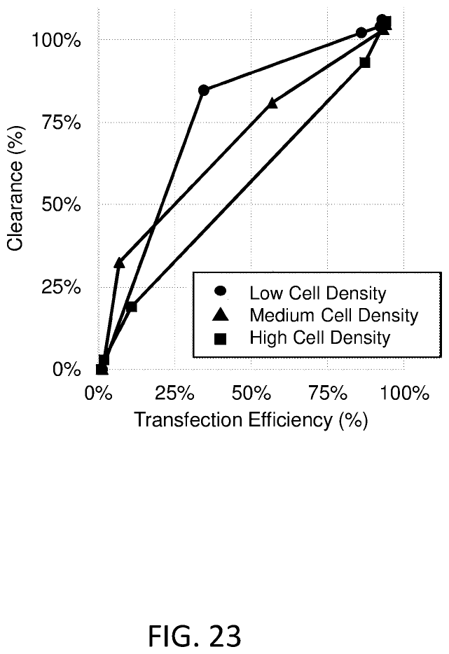

FIG. 22 shows a graph with the x-axis showing transfection efficiency as a percentage, and the y-axis showing bubble clearance as a percentage, according to embodiments. Samples with A549 cells were assessed. Clearance was measured as described with respect to FIG. 21. Transfection efficiency for the samples was measured using flow cytometry. FIG. 22 shows a correlation between bubble clearance measured during transfection and the percentage of cells successfully transfected with a green fluorescent protein (GFP) encoding mRNA. Transfection efficiency was assessed using flow cytometry to measure the expression in of GFP in individual cells. A similar correlation was observed with HEK-293 cells, as shown in FIG. 23. These correlations indicate bubble assessment before and after destruction techniques may be used as a predictor of transfection success for one or more cell types, thereby enabling real-time process improvement through dynamic adjustment of the number, amplitude, and/or duration of bubble-destroying signals to correct for insufficient clearance of microbubbles.

Many of the embodiments described herein, as will be understood, may be implemented on or in conjunction with a computer storage product with a non-transitory computer-readable medium (also can be referred to as a non-transitory processor-readable medium) having instructions or computer code thereon for performing various computer-implemented operations. These embodiments may include the ones that involve processor 143 (or relevant portions of such embodiments). The medium can include one or more distinct media. The code may be executed on one or more processors, such as processor 143 (which itself may include multiple processors). The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware (e.g., processor 143), or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.), interpreted languages (JavaScript, typescript, Perl) or other suitable programming languages and/or development tools. Additional examples of computer code include, but are not limited to, control signals, encrypted code, and compressed code.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1-74. (canceled)

75. A system for analyzing a sample contained in a container, wherein the container includes a bottom surface having a bottom-of-bottom interface (BB) and a top-of-bottom interface (TB), the system comprising:
a transducer assembly configured to receive a plurality electronic transmission signals and emit a corresponding plurality of transmitted acoustic signals towards the container and the sample, and configured to receive reflected acoustic signals from at least one of the container or the sample and generate a corresponding plurality of electronic reception signals;
transmit signal circuitry configured to provide the electronic transmission signals to the transducer assembly;
receive signal circuitry configured to receive the electronic reception signals from the transducer assembly; and
a processor configured to control the transmit signal circuitry and receive information corresponding to the electronic reception signals from the receive signal circuitry,
wherein the plurality of transmitted acoustic signals comprises at least a first ping, and a first bubble-destroying signal,
wherein the plurality of reflected acoustic signals comprises at least a first TB reflection corresponding to the first ping, and
wherein the system is configured to emit a the first bubble-destroying signal based on a characteristic of the first TB reflection.

76. The system of claim 75, wherein
the plurality of transmitted acoustic signals comprises a sequence of the first ping, the first bubble-destroying signal, and a second ping;
the plurality of reflected acoustic signals further comprises a second TB reflection corresponding to the second ping; and
the system is further configured to emit a second bubble-destroying signal based on a comparison of a characteristic of the first TB reflection and a characteristic of the second TB reflection.

77. The system of claim 76, wherein the characteristic of the first TB reflection comprises a first peak amplitude and the characteristic of the second TB reflection comprises a second peak amplitude, and
wherein system is further configured to emit the second bubble-destroying signal if the first peak amplitude is greater than the second peak amplitude.

78. The system of claim 76, wherein a peak amplitude of the first ping and a peak amplitude of the second ping are substantially identical.

79. The system of claim 76, wherein an overall energy of a bubble-destroying signal is greater than an overall energy of a ping.

80. The system of claim 76, wherein the transducer assembly is configured to focus acoustic energy at a first height when emitting the first ping, the first bubble-destroying signal, and the second ping, and wherein the transducer assembly is configured to focus acoustic energy at a second height above the first height when emitting the second bubble-destroying signal; and wherein (i) the first height is predetermined with respect to the TB, and wherein the second height is substantially at a surface of the sample; or (ii) the first height is between +/−6 mm with respect to the TB.

81. The system of claim 76, wherein the second bubble-destroying signal includes a pre-conditioning signal selected to destroy bubbles and a subsequent conditioning signal selected to destroy bubbles; and wherein the pre-conditioning signal is a bubble-destroying signal.

82. The system of claim 76, wherein the container is included in a plate comprising a plurality of containers containing a corresponding plurality of samples,
wherein each of the plurality of containers includes a corresponding BB and TB,
wherein the system further comprises at least one motor configured to move at least one of the plate or the transducer assembly, such that the transducer assembly is positioned underneath each of the plurality of containers.

83. The system of claim 82,
wherein the system is further configured to cause the transducer assembly to emit the sequence of the first ping, the first bubble-destroying signal, and the second ping for each of the plurality of containers, and
wherein the system is further configured to cause the transducer assembly to emit the second bubble-destroying signal for given ones of the plurality of containers based on comparisons of a characteristic of the first TB reflection for a given container and a characteristic of the second TB reflection for the given container; and
wherein the system is further configured to emit the second bubble-destroying signals for given ones of the plurality of containers after the first ping, the first bubble-destroying signal, and the second ping have been emitted for each of the plurality of containers.

84. A method for analyzing a sample contained in a container, wherein the container includes a bottom surface having a bottom-of-bottom interface (BB) and a top-of-bottom interface (TB), the method comprising:
receiving, at a transducer assembly, a plurality of electronic transmission signals;
transmitting, by the transducer assembly, a plurality of transmitted acoustic signals towards the container and the sample, wherein the plurality of transmitted acoustic signals correspond to the plurality of electronic transmission signals;
receiving, at the transducer assembly, a plurality of reflected acoustic signals from at least one of the container or the sample;
generating, by the transducer assembly, a plurality of electronic reception signals corresponding to the plurality of reflected acoustic signals;
providing, by transmit signal circuitry, the plurality of electronic transmission signals to the transducer assembly;
receiving, at receive signal circuitry, the plurality of electronic reception signals from the transducer assembly;
controlling, with a processor, the transmit signal circuitry; and
receiving, at the processor, information corresponding to the electronic reception signals from the receive signal circuitry,
wherein the plurality of transmitted acoustic signals comprises at least a first ping,
wherein the plurality of reflected acoustic signals comprises at least a first TB reflection corresponding to the first ping and
further comprising, emitting, by the transducer assembly, at least a first bubble-destroying signal based on a characteristic of the first TB reflection.

85. A method according to claim 84, wherein the plurality of transmitted acoustic signals further comprises a second ping;
the plurality of reflected acoustic signals further comprises a second TB reflection corresponding to the second ping; and
the method further comprises emitting, by the transducer assembly, a second bubble-destroying signal based on a comparison of a characteristic of the first TB reflection and a characteristic of the second TB reflection.

86. The method of claim 85, wherein the characteristic of the first TB reflection comprises a first peak amplitude and the characteristic of the second TB reflection comprises a second peak amplitude, and further comprising emitting, by the transducer assembly, the second bubble-destroying signal if the first peak amplitude is greater than the second peak amplitude.

87. The method of claim 85, wherein a peak amplitude of the first ping and a peak amplitude of the second ping are substantially identical.

88. The method of claim 85, further comprising:
focusing, with the transducer assembly, acoustic energy at a first height when emitting the first ping, the first bubble-destroying signal, and the second ping; and
focusing, with the transducer assembly, acoustic energy at a second height above the first height when emitting the second bubble-destroying signal;
and wherein
(i) the first height is predetermined with respect to the TB, and wherein the second height is substantially at a surface of the sample; or
(ii) the first height is between +/−6 mm with respect to the TB.

89. The method of claim 85, wherein the container is included in a plate comprising a plurality of containers containing a corresponding plurality of samples, wherein each of the plurality of containers includes a corresponding BB and TB, and further comprising:
moving, with at least one motor, at least one of the plate or the transducer assembly, such that the transducer assembly is positioned underneath each of the plurality of containers at different times;
emitting, by the transducer assembly, a sequence of the first ping, the first bubble-destroying signal, and the second ping for each of the plurality of containers; and
emitting, by the transducer assembly, the second bubble-destroying signal for given ones of the plurality of containers based on comparisons of a characteristic of the first TB reflection for a given container and a characteristic of the second TB reflection for the given container; and
wherein the method further comprises emitting the second bubble-destroying signals for given ones of the plurality of containers after the first ping, the first bubble-destroying signal, and the second ping have been emitted for each of the plurality of containers.
